(19) United States
(12) Patent Application Publication
(10) Pub. No.: US 2013/0197861 A1
(43) Pub. Date: Aug. 1, 2013

(54) Method for spectrometric analysis and related device

(71) Applicants: Eric Barat, Limours (FR); Thomas Dautremer, Palaiseau (FR); Thierry Montagu, Paris (FR)

(72) Inventors: Eric Barat, Limours (FR); Thomas Dautremer, Palaiseau (FR); Thierry Montagu, Paris (FR)

(73) Assignee: Commissariat a l'Energie Atomique et aux Energies Alternatives, Paris (FR)

(21) Appl. No.: 13/639,079

(22) PCT Filed: Mar. 14, 2011
(86) PCT No.: PCT/EP2011/053774

§ 371 Date: Oct. 25, 2012

(30) Foreign Application Priority Data
Apr. 2, 2010 (FR) 10 52526

(51) Int. Cl. G06F 17/18

(52) U.S. Cl. CPC G06F 17/18
USPC 702/180

(57) ABSTRACT

A method for analyzing spectrometric measurements, said measurements C={c₁, . . . , cᵣ} being organized in a histogram, said histogram being made up of accumulation channels, a channel j corresponding to an energy interval Bⱼ, comprises at least three processing steps. A first step determines, for each accumulation channel j, distributions p representative of the amplitude and Z representative of the position of the Dirac pulses that make up the normalized spectrum of peaks as well as distributions q representative of the Pólya tree characterizing the normalized background spectrum, said elements being obtained by Gibbs sampling. A second step detects significant channels, said detection being performed by application of a Kolmogorov-Smirnov test for each accumulation channel of the histogram on the basis of the results of the first step. A third step identifies significant regions of the spectrum by grouping together intervals Bⱼ of the significant channels identified during the second step, said regions including at least one significant peak.

The invention relates to a spectrometric analysis method and a related device. The invention applies notably to the fields of Gamma spectrometry, X spectrometry and time-of-flight mass spectrometry.

The aim of the analysis of spectrometric data is notably to identify an unknown number of peaks superposed on a background that is also unknown, said peaks being representative of physical quantities present in the medium to be analyzed.

A number of difficulties affect this analysis. The form of the peaks present in the spectrum can usually be modeled only partially by parameterizable functions. Similarly, it is difficult to decompose the backgrounds by using a base of parameterizable functions. The fact that the number of peaks is unknown also complicates the analysis.

A number of automatic spectrum analysis methods are proposed in the prior art to circumvent these difficulties and facilitate the analysis of spectrometric data. Two categories of the methods can be distinguished.

A first category comprises the analysis methods that rely on databases. These techniques are widely used in the field of nuclear spectrometry and mass spectrometry. The principle is to search for the peaks in a database which characterizes them in position and in intensity. This type of method makes it possible to search for the positions and intensities over continuous spaces by fixing the number of components. It is then possible to estimate the quantity of each element that makes up the database by minimizing a cost function. The form of the peaks is, in this case, assumed to be deterministic and known. As for the background, this is modeled beforehand under each peak of a given region of interest by a polynomial function. The use of an adjustment procedure and of fixed parametric models on noise-affected data induces a reconstruction error consisting of two components, the first corresponding to a statistical error and the second to a model error. Furthermore, this approach presupposes the accuracy of the reference database, this assumption being rarely verified given that there is a significant contribution from trial and error in the creation of said bases. It is then difficult to estimate the total uncertainty linked to the analysis.

A second category comprises analysis methods based on an automatic detection of peaks. This approach does not require the use of databases but follows a statistical approach based on minimizing a risk or maximizing likelihood.

The search for the position of said peaks is performed over a discrete space made up of the channels of the spectrum acquired. In practice, multichannel analyzers are usually used to analyze spectra such as X or γ spectra. Technical constraints, such as the limited resolution of the analog-digital converters for example, mean that it is not possible to directly generate a continuous spectrum. This is why these analyzers present as output histograms made up of a number of channels. A histogram channel j corresponds, for example, to an energy interval Bⱼ, the quantities to be measured, of photons for example, are organized by channels according to energy level. Two distinct peaks can be detected if they are separated by at least one spectral channel. These channels are also called accumulation channels hereinafter in the description. The set of the accumulation channels representative of a spectrum make up a histogram.

In the context of the analysis methods based on an automatic detection of peaks, the estimation of the intensity of the peaks is applied over a continuous space. The number of peaks can be assumed to be known in advance over a limited region of interest or else estimated from the data. The backgrounds can be estimated empirically or modeled according to linear combinations of splines such as B-splines for example. In all cases, the number of peaks is finite. The finite number of peaks sought and the parameterized form of said peaks induces a statistical error and a model error in the reconstruction of the spectrum. By using a noise assumption, said noise corresponding to the statistical nature of the noise in a histogram channel, it is possible to access the uncertainty of the measurements by using the inverse of the Hessien matrix. This estimation is effective for a Gaussian noise assumption, but is not representative of the reality in the case of Poisson noise, and does not take into account any model errors.

An example of an automatic peak detection method is described in the article by S. Gulam Razul, W. J. Fitzgerald and C. Andrieu entitled Bayesian model selection and parameter estimation of nuclear emission spectra using RJMCMC, Elsevier, Nuclear Instrument and Methods in Physics Research, A 497, pages 492-510, 2003. This approach is parametric in as much as an unknown but finite number of peaks is considered.

The spectrometric analysis methods described previously do not allow for a reliable detection of the peaks present in the spectrum when the number of peaks present is potentially infinite. Furthermore, it is not possible to estimate the level of uncertainty of said detection for each accumulation channel.

Advantageously, the proposed method takes into account the quantization noise due to the fact that the traditional acquisition systems store the samples of measurements in histograms. The invention also offers the advantage of allowing for an implementation which does not require significant computational power, the processing operations being performed for each accumulation channel and not for each sample.

One aim of the invention is notably to mitigate the abovementioned drawbacks.

To this end, the subject of the invention is a method for analyzing spectrometric measurements, said measurements C={c₁, . . . , cᵣ} being organized in a histogram, said histogram being made up of accumulation channels, a channel j corresponding to an energy interval Bⱼ. Said method comprises at least three processing steps. A first step determines, for each accumulation channel j, distributions p representative of the amplitude and Z representative of the position of the Dirac pulses that make up the normalized spectrum of peaks as well as distributions q representative of the Pólya tree characterizing the normalized background spectrum, said elements being obtained by Gibbs sampling. A second step detects significant channels, said detection being performed by the application of a Kolmogorov-Smirnov test for each accumulation channel of the histogram on the basis of the results of the first step. A third step identifies significant regions of the spectrum by grouping together the intervals Bⱼ of the significant channels identified during the second step, said regions including at least one significant peak.

Method according to one aspect of the invention, the spectrum of peaks is determined for any accumulation channel of index j, by using Monte-Carlo estimators defined by an expression such as:

$$E ( wn {\prod }_{j} \vert C ) = \frac{n}{L} {\sum }_{l = 1}^{L} {w}^{( l )} {Π}_{j}^{( l )}$$

in which:
Πⱼ^{(l)} corresponds to the probability mass of the channel Bⱼ for the l^{th} draw of the MCMC process;
L corresponds to the number of Monte Carlo draws of the Gibbs sampler;
wε[0.1] is the probability of the spectrum of peaks in the complete spectrum defined as being the weighted sum of the normalized spectrum of peaks and of the normalized background spectrum;
w^{(l)} represents the weight of the spectrum of peaks for the l^{th} draw of the MCMC process;
n is the number of photons recorded.

The background spectrum is determined, for example, for any accumulation channel of index j, by using the following expression:

$$E ( ( 1 - w ) n {Φ}_{j} \vert C ) = \frac{n}{L} {\sum }_{l = 1}^{L} ( 1 - {w}^{( l )} ) {Φ}_{j}^{( l )}$$

in which:
Φⱼ^{(l)} represents the generated values of the random variable Φⱼ on the iteration l of the sampler, Φⱼ representing the probability mass of the channel Bⱼ of the normalized background spectrum for each j.

The uncertainty associated with each energy channel is estimated for example by defining a 95% credibility interval [\tilde{η}₋,\tilde{η}₊] determined by using the following expressions:

$${\tilde{η}}_{-} = {min}_{η} ( Pr ( wn {Π}_{j} < η ) \geq 0.025 ) \approx n {\{ {w}^{( l )} {Π}_{j}^{( l )} \}}^{↑} ( ⌊ 0.025 L ⌋ )$$

$${\tilde{η}}_{+} = {min}_{η} ( Pr ( wn {Π}_{j} < η ) \geq 0.975 ) \approx n {\{ {w}^{( l )} {Π}_{j}^{( l )} \}}^{↑} ( ⌊ 0.975 L ⌋ )$$

in which:
for any x, the notation {x}^{↑} represents the collection of the samples x sorted in ascending order;
for any x and for any j, the notation {x}^{↑}(j) represents the j^{th} sample of the collection x sorted in ascending order;
thus, {w^{(l)}Πⱼ^{(l)}}^{↑} represents the collection of the samples generated w^{(l)Π}ⱼ^{(l)} sorted in ascending order;
└•┘ indicates the integer portion;
n represents the total number of photons recorded;
η represents a variable characterizing the intensity of the spectrum of peaks for the energy channel considered.

A quantity D_{L}(Γⱼ,Σⱼ) is determined for example, for application of the Kolmogorov-Smirnov test (210) by using the expression:

$${D}_{L} ( {Γ}_{j} , {Σ}_{j} ) = \sqrt{\frac{L}{2}} {sup}_{η} \vert {CDF}_{\{ {Γ}_{j}^{( l )} \}} ( η ) - {CDF}_{\{ {Σ}_{j}^{( l )} \}} ( η ) \vert$$

in which:
Σⱼ corresponds to the probability of the channel Bⱼ in the complete normalized spectrum;
Γⱼ is a quantity corresponding to the background alone;
{Σⱼ^{(l)}} represents the collection of the samples generated Σⱼ^{(l)} for l≦L;
{Γⱼ^{(l)} represents the collection of the samples generated Γ}ⱼ^{(l)} for l≦L;
CDF_{{Σ}_{ⱼ}_{^{(l)}}_{}}(η) the empirical cumulative function of the distribution of Σⱼ such that

$${CDF}_{\{ {Σ}_{j}^{( l )} \}} ( η ) = \frac{1}{L} {\sum }_{l = 1}^{L} ( {Σ}_{j}^{( l )} < η ) ;$$

CDF_{{Γ}_{ⱼ}_{^{(l)}}_{}}(η) the empirical cumulative function of the distribution of Γⱼ such that

$${CDF}_{\{ {Γ}_{j}^{( l )} \}} ( η ) = \frac{1}{L} {\sum }_{l = 1}^{L} ( {Γ}_{j}^{( l )} < η ) ;$$

η represents a variable characterizing the intensity of the complete spectrum for the energy channel considered.

The presence of a significant peak element over an interval Bⱼ is detected, for example, if D_{L}(Γⱼ,Σⱼ)>K_{α}, K_{α} being defined such that Pr(K≦K_{α})=1−α, α corresponding to a chosen level of significance.

The method according to the invention comprises, for example, a step of estimating the intensity of the peaks over a significant region Rₘ, said intensity being determined by using the expressions:

$${\hat{λ}}_{m} = \frac{1}{L} {\sum }_{l = 1}^{L} with {λ}_{m}^{( l )} = {nw}^{( l )} {\sum }_{k = 1}^{N} {p}_{k}^{( l )} 1 ( {Z}_{k}^{( l )} ∈ {R}_{m} )$$

in which:
the function 1(Cond)=1 if the condition Cond is true and 1(Cond)=0 otherwise;
{Rₘ} the collection of significant regions of the spectrum;
Zₖ is the position of the component k of the Dirichlet process produced by the MCMC procedure.

The method according to the invention comprises, for example, a step of computing a 95% credibility interval for λₘ by using the expression:

CI_{95%}(λₘ)=└{λₘ^{(l)}}^{↑}(└0.025L┘),{λₘ^{(l)}}^{↑}(└0.975L┘)┘
in which the collection {λₘ^{(l)}}^{↑} corresponds to the collection of samples {λₘ^{(l)}} arranged in ascending order.

The method according to the invention comprises, for example, a step of estimating the centroid \hat{μ}ₘ of each region of significant peaks by using the following expression:

$${\hat{μ}}_{m} = \frac{{\sum }_{l = 1}^{L} {μ}_{m}^{( l )}}{{\sum }_{l = 1}^{L} 1 ( {N}_{m}^{( l )} > 0 )}$$

in which:
μₘ^{(l)} is a quantity estimated over each significant region Rₘ and for each draw of the MCMC procedure by using the expression:

$${μ}_{m}^{( l )} = {\sum }_{k = 1}^{N} {\tilde{p}}_{k}^{( l )} {Z}_{k}^{( l )} 1 ( {Z}_{k}^{( l )} ∈ {R}_{m} ) ;$$

the denominator corresponds to the number of MCMC draws for which there is at least one component belonging to the region Rₘ, the other draws not being able to be taken into account in the Monte Carlo estimation.

The method according to the invention comprises, for example, a step of computing a 95% credibility interval for μₘ by using the expression:

CI_{95%}(μₘ)=└{μₘ^{(l)}}^{↑}(└0.025L┘),{μₘ^{(l)}}^{↑}(└0.975L┘)┘
in which the collection {μₘ^{(l)}}^{↑} corresponds to the collection of samples {μₘ^{(l)}} arranged in ascending order.

The method according to the invention comprises, for example, a step of estimating \hat{σ}ₘ the standard deviation σₘ of the energy distribution restricted to the region Rₘ by using the expression:

$${\hat{σ}}_{m} = \frac{{\sum }_{l = 1}^{L} {σ}_{m}^{( l )}}{{\sum }_{l = 1}^{L} 1 ( {N}_{m}^{( l )} > 0 )}$$

in which:

$${σ}_{m}^{( l )} = \sqrt{( {\sum }_{k = 1}^{N} {{\tilde{p}}_{k}^{( l )} ( {Z}_{k}^{( l )} )}^{2} 1 ( {Z}_{k}^{( l )} ∈ {R}_{m} ) ) - {( {\sum }_{k = 1}^{N} {\tilde{p}}_{k}^{( l )} {Z}_{k}^{( l )} 1 ( {Z}_{k}^{( l )} ∈ {R}_{m} ) )}^{2}}$$

The method according to the invention comprises, for example, a step of computing a 95% credibility interval for σₘ by using the expression:

CI_{95%}(σₘ)=└{σₘ^{(l)}}^{↑}(└0.025L┘),{σₘ^{(l)}}^{↑}(└0.975L┘)┘
in which the collection {σₘ^{(l)}}^{↑} corresponds to the collection of samples {σₘ^{(l)}} arranged in ascending order.

The method according to the invention comprises, for example, a step of estimating the width of the deconvoluted region at its base, defined as the interval of 99% higher probability of the restriction to Rₘ of the energy density (denoted Δ_{m,99%}), by using the expression

$${\hat{Δ}}_{m , 99 \%} = \frac{{\sum }_{l = 1}^{L} {Δ}_{m , 99 \%}^{( l )}}{{\sum }_{l = 1}^{L} 1 ( {N}_{m}^{( l )} > 0 )}$$

in which:

Δ_{m,99%}^{(l)}=[Q_{R}_{ₘ}^{(l)}(0.005),Q_{R}_{ₘ}^{(l)}(0.995)] where

$${Q}_{{R}_{m}}^{( l )} ( α ) = {ξ}_{α} {CDF}_{{R}_{m}}^{( l )} ( {ξ}_{α} ) = α and \\ {CDF}_{{R}_{m}}^{( l )} ( ξ ) = {\sum }_{k = 1}^{N} {\tilde{p}}_{l}^{( l )} 1 ( {Z}_{k}^{( l )} < ξ ) 1 ( {Z}_{k}^{( l )} ∈ {R}_{m} ) .$$

The method according to the invention comprises, for example, a step of computing a 95% credibility interval for Δ_{m,99%} by using the expression:

CI_{95%}(Δ_{m,99%})=[{Δ_{m,99%}^{(l)}}^{↑}(└0.025L┘),{Δ_{m,99%}^{(l)}}^{↑}(└0.975L┘)]
in which the collection {Δ_{m,99%}^{(l)}}^{↑} corresponds to the collection of samples {Δ_{m,99%}^{(l)}} arranged in ascending order.

Another subject of the invention is a device for analyzing spectrometric measurements, said measurements C={c₁, . . . , cᵣ} being organized in a histogram, said histogram being made up of accumulation channels, a channel j corresponding to an energy interval Bⱼ, said device being characterized in that it comprises means for implementing the method described previously.

Other features and advantages of the invention will become apparent from the following description given in an illustrative and nonlimiting manner, in light of the appended drawings in which:

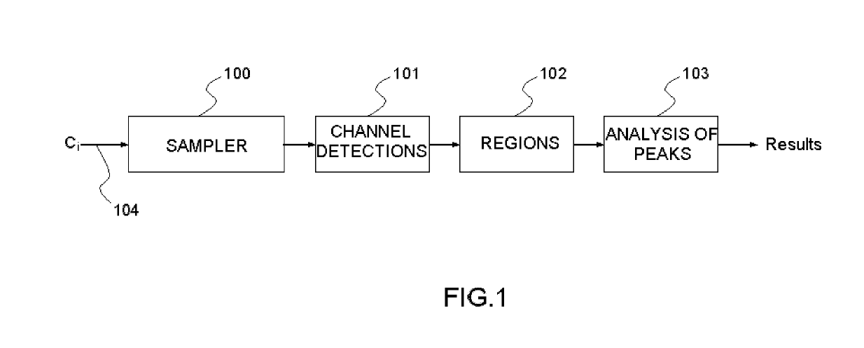

FIG. 1 illustrates the principle of the spectrum analysis method according to the invention;

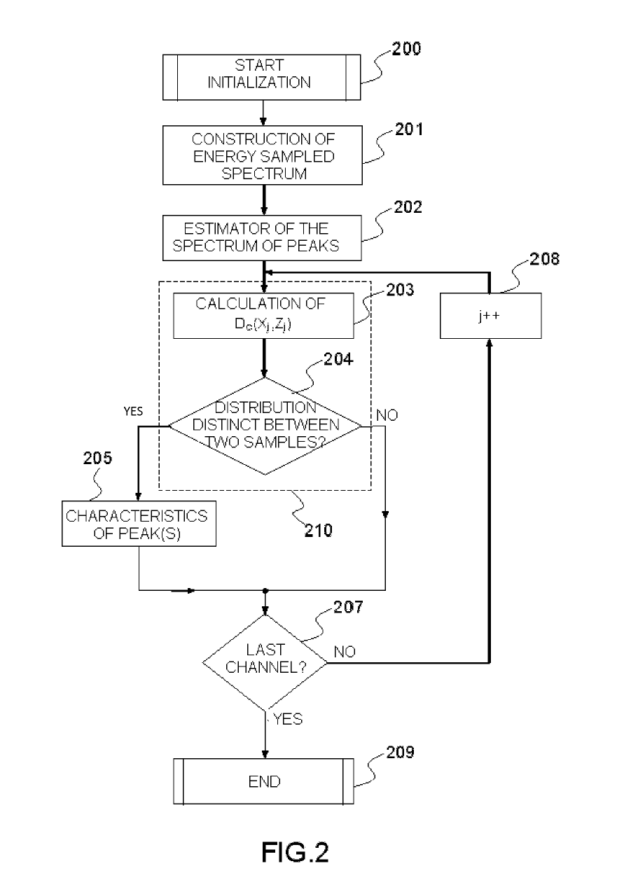

FIG. 2 gives an example of a sampled spectrum construction and analysis method;

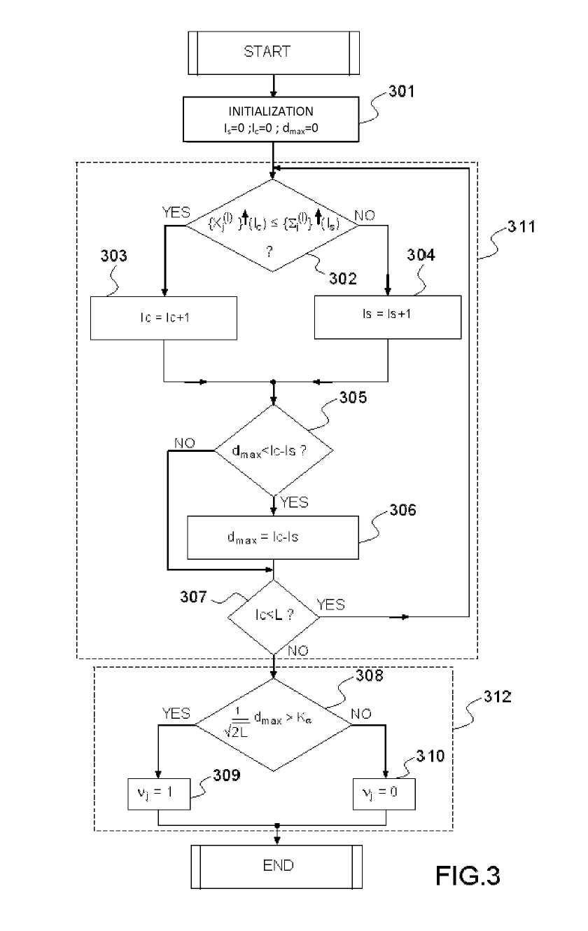

FIG. 3 gives an example of the implementation of the Kolmogorov-Smirnov test in the context of a semi-parametric Bayesian spectrometry application;

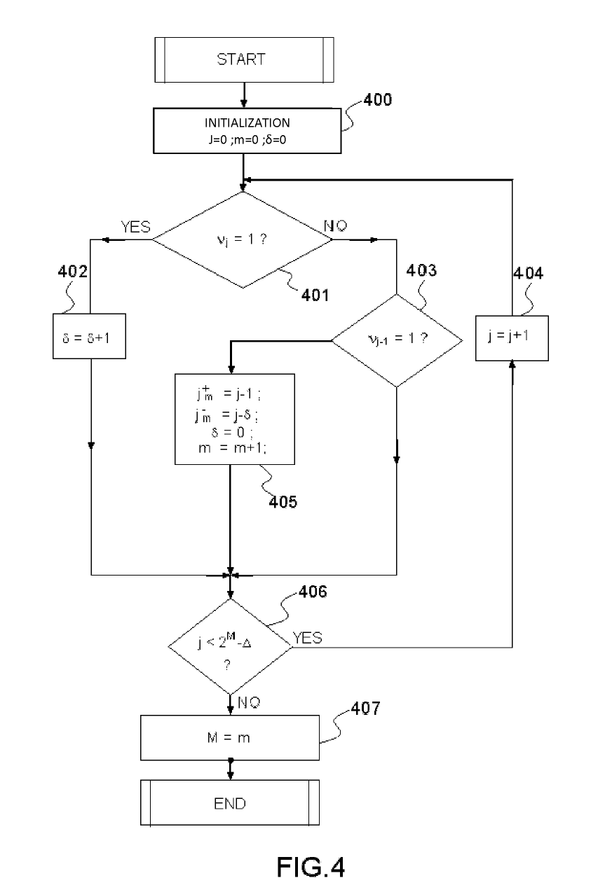

FIG. 4 gives an example of the sequential construction process of the regions of significant peaks;

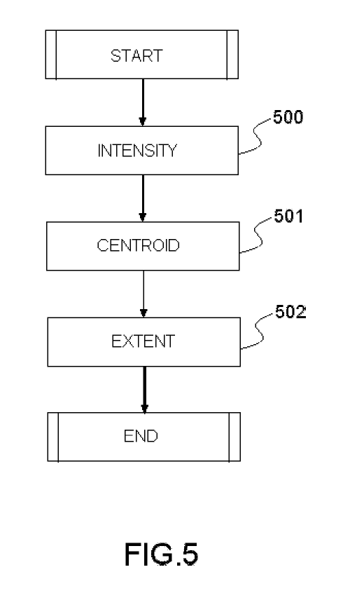

FIG. 5 illustrates the analyses that can be conducted after the application of the Kolmogorov-Smirnov test in order to analyze the detected peaks.

FIG. 1 illustrates the principle of the spectrum analysis method according to the invention. This comprises a Gibbs sampler module 100 and a sampled spectrum construction and analysis module 101.

In the article by E. Barat et al. T. Dautremer and T. Montagu entitled Nonparametric bayesian inference in nuclear spectrometry, IEEE Nuclear Science Symposium Record, NSS/MI 2007, an extension of the automatic peak detection methods described previously is presented. This extension proposes considering the number of peaks as potentially infinite. The principle is to look for a probability measurement which, by convolution of a kernel, gives a probability distribution for which ranked samples form the observed histogram, a kernel here being a positive function, normalized at 1, corresponding to the distribution of the instrumental noise varying with the position on the histogram, said position corresponding, for example, to an energy or mass level.

The statistical nature of the noise of an accumulation channel is taken into account because the histogram corresponds to the ranked counting of a collection of executions generated by a probability distribution. This approach has a non-parametric character in as much as a quantity that can evolve anywhere in the space of the distributions of probabilities over the space of the positions is estimated. Thus, a possible model imperfection in the form of the peaks, corresponding to instrumental noise will be included by the probability measurement sought by means of the potential presence of an infinity of peaks.

Moreover, the background is also modeled by a probability measurement obtained by convolution with the same kernel. The discrimination between the probability measurement corresponding to the peaks and that corresponding to the background is based on the fact that the distribution of the peaks without convolution exhibits a discrete character compared to the distribution without convolution of the background, which is assumed continuous at this modeling level. Furthermore, this method also has a parametric character in that the density of the instrumental noise distribution is assumed parametric, but does not necessarily seek to fully estimate the potentially complex form of the peak. This density can be, for example, Gaussian for a gamma spectrum, or correspond to a Voigt function for an X spectrum. For these reasons, this approach can be qualified as semi-parametric. This method, unlike the techniques recalled previously, guarantees that all of the impulses present in the observed spectrum lie within the sum of the spectrum and of the deconvoluted background. There is thus conservation of the whole of the spectrum. Starting from a histogram, a deconvoluted spectrum is obtained with, on one side, the peaks and, on the other side, the background. The whole of said spectrum is strictly identical to that of the starting histogram. The resolution of the spectrum obtained is significantly enhanced compared to the initial spectrum, without in any way being limited to searching for a finite number of peaks.

This result is obtained by using the Gibbs sampling method, said method forming part of the MCMC methods, MCMC standing for “Markov Chain Monte Carlo”.

The method proposed in the context of the invention uses a Gibbs sampler 100, said sampler notably having three objectives.

The first objective is to automatically separate the peaks from the background over the whole of the spectrum, and to do so non-parametrically.

The second objective is to enhance the output resolution by producing a deconvolution of Gaussian form. In practice, the peaks to be detected are usually spread before processing and have a form that can be likened to a Gaussian curve. The deconvolution makes it possible to reduce the width of the peaks to be detected. Consequently, the width of the peaks is reduced and the detection accuracy is thus enhanced.

Finally, the sampler provides a random draw of the elements that make up the normalized peak spectrum and the normalized (to 1) background spectrum. These different random draws correspond to:
the amplitude p of the Dirac pulses, said pulses also being called Dirac masses;
the position Z of said Dirac masses;
the amplitude q of the background.
p and Z are random draws representative of the normalized spectrum of the peaks and are expressed in the space of the energies in the form of vectors.
q is a random draw representative of the normalized background spectrum and expressed in vector form.

The Gibbs sampling applied in the context of the spectrometry as described in the article by E. Barat et al. cited previously can be implemented in order to obtain the distributions of p, Z and q.

The sampling module 100 is capable of processing samples of measurements collected in the form of histograms 104 by a multichannel analyzer, said input data being able to be written in the form of a vector C:

C={c₁, . . . ,cᵣ}

in which the elements c₁ represent the number of impulses in the j^{th} accumulation channel Bⱼ, a number of impulses cⱼ being equivalent to a number of pulses generated by the detector.

Other input data are required by the Gibbs sampler in order to generate the random draws p, Z and q. Thus, preconceptions, that is to say conditional probability distributions, are computed by using non-parametric Bayesian inference techniques. The Dirichlet process and Pólya trees can thus be used to determine said preconceptions as described in the article by E. Barat et al. cited previously in the description.

The technique of deconvolution and of separation of the peaks and of the backgrounds presented previously has a number of properties.

A first property is that this technique is non-parametric. In other words, the solution is sought in the set containing all the distributions of probabilities with positive real values. This set is denoted M( [symbol] ⁺).

A second property is linked to its Bayesian character. The a posteriori distribution of the Dirichlet processes is available after Gibbs sampling and can be determined by the collection of random draws of p and Z. The a posteriori distribution of the Pólya trees can be determined by the collection of random draws of q.

The non-parametric character of this technique allows for great modeling flexibility since it is unencumbered by any finite and predetermined list of possible positions of energy peaks. Advantageously, each random draw occurring in the MCMC sampling procedure 100 on a spectrum of deconvoluted peaks (Dirichlet process) is thus a discrete probability distribution in which the number of masses, that is to say of deconvoluted peaks, is potentially infinite.

This modeling flexibility does, however, induce a difficulty of interpretation. During the iterations of the MCMC procedure it is possible for Dirac masses to appear at any energy value, leading asymptotically to a quasi-continuous measured quantity. In order to provide the user with a list of positions and intensities of peaks that can be interpreted, it is possible to determine significant regions, that is to say energy intervals that cannot be explained statistically by a random fluctuation of the background. The Bayesian character here offers a key element.

The a posteriori access to the distributions makes it possible firstly to implement an estimator of the deconvoluted spectrum of peaks but also makes it possible to estimate the uncertainty associated with this spectrum of peaks for any energy interval (region). The uncertainty can also be determined for the background spectrum.

Hereinafter in the description, the generation of the random draws by the Gibbs sampler is also referred to by the expression “MCMC procedure”.

Thus, following the generation of the random draws by the MCMC procedure, the objective pursued is to analyze a spectrum sampled in energy channels in order to detect and to characterize significant peaks, that is to say peaks of the spectrum that are representative of physical quantities present in the medium being measured by spectrometry. Thus, a detection of the significant channels is conducted 101, the significant channels being channels including measurements relating to a significant peak. The significant channels are then grouped together into significant regions 102 and the peaks present in said regions are then analyzed 103, the results being presented as output, for example on a screen. Examples of implementation of these processing operations are detailed later in the description with the help of FIGS. 2 to 4.

FIG. 2 gives an example of a method of constructing and detecting significant channels.

The method described below requires the use of the a posteriori distributions obtained by the semi-parametric Bayesian inference method, that is to say by the Gibbs sampler described previously. The accumulation channels are processed one after the other, the channel of index j denoted Bⱼ being the current channel.

After Gibbs sampling, the amplitude p of the Dirac masses, the position Z of said Dirac masses and the amplitude q of the background are used by the sampled spectrum construction and analysis method according to the invention.

After initialization 200, a spectrum of peaks sampled in energy for each accumulation channel is constructed 201 to allow for the detection of significant regions including peaks.

The principle of detection of the significant regions relies firstly on a statistical test performed over each energy interval B, forming a channel. Then, a significant region is defined as a set of contiguous channels for which the statistical test is positive.

The number L of Monte Carlo draws of the Gibbs sampler defines the size of the population of the events used to carry out the statistical test. A limited value of L does not guarantee finding probability masses obtained from the draws of the Dirichlet process in significant numbers over each interval Bⱼ of a significant region. A condition guaranteeing that the number of Monte Carlo draws is sufficient is that \sqrt{L}>>Tₘₐₓ where Tₘₐₓ is the number of channels of the largest significant region. In practice, the user adjusts the number L according to the size of the significant regions obtained.

For each random draw of the MCMC procedure and for any j, the quantity Πⱼ is defined as being the probability mass of the channel Bⱼ of the normalized spectrum of peaks:

$${Π}_{j} = {\sum }_{k = 1}^{N} {p}_{k} 1 ( {Z}_{k} ∈ {B}_{j} ) \qquad ( 1 )$$

in which expression:
j is the index associated with a given interval Bⱼ;
N is the number of components (Dirac masses) of the Dirichlet process for the draw considered;
Zₖ is the position of the component k of the Dirichlet process produced by the MCMC procedure;
the function 1(Cond)=1 if the condition Cond is true and 1(Cond)=0 otherwise.

In parallel, Φⱼ the probability mass of the channel Bⱼ of the normalized background spectrum, is defined for each j by:

Φⱼ=qⱼ (2)

The normalized spectrum of peaks can then be estimated 201, so that it can be used for the detection of significant regions including peaks.

L draws from the Gibbs sampler are available.

Hereinafter in the description, the notation Πⱼ^{(l)} represents the values generated for the random variable Πⱼ on the iteration l of the sampler. Similarly, the notation Φⱼ^{(l)} represents the values generated for the random variable Φⱼ on the iteration l of the sampler.

An estimator of the spectrum of peaks is chosen, for example, as being the conditional average of Πⱼ weighted by the average number of photons recorded assigned to the peaks (w·n) where n is the number of photons recorded and wε[0.1] is the probability of the spectrum of peaks in the complete spectrum defined as being the weighted sum of the normalized spectrum of peaks and of the normalized background spectrum. The exemplary application chosen is that of Gamma spectrometry, but the method described can be used in the context of X spectrometry or of time-of-flight mass spectrometry, to give a few examples.

For any accumulation channel of index j, Monte-Carlo estimators are constructed by using the following expression:

$$E ( wn {Π}_{j} \vert C ) = \frac{n}{L} {\sum }_{j = 1}^{L} {w}^{( l )} {Π}_{j}^{( l )} \qquad ( 3 )$$

in which:
C represents the observed histogram containing, in each channel Bⱼ, the sum of the events (photons) for which the energy belongs to Bⱼ. C can also be designated by the expressions “data” or “observations”.

When it comes to the estimation of the background, the following expression is used:

$$E ( ( 1 - w ) n {Φ}_{j} \vert C ) = \frac{n}{L} {\sum }_{l = 1}^{L} ( 1 - {w}^{( l )} ) {Φ}_{j}^{( l )} \qquad ( 4 )$$

in which:
w^{(l)} represents the weight of the spectrum of peaks for the l^{th} draw of the MCMC process.

The values of E(w n Πⱼ|C) and of E((1−w)nΦ₁|C) can, for example, be represented graphically using a display device.

These estimators offer the user a global representation of the density of the deconvoluted energy distribution. Advantageously, the proposed method makes it possible, over and above simply computing the a posteriori average, to determine a credibility interval, for example 95%, over each interval Bⱼ.

Thus, the uncertainty associated with each energy channel is estimated, for example, by defining a 95% credibility interval [\tilde{η}₋,\tilde{η}₊] determined by using the expressions:

$$\begin{matrix}{\tilde{η}}_{-} = {min}_{η} ( Pr ( wn {Π}_{j} < η ) \geq 0.025 ) \approx n {\{ {w}^{( l )} {Π}_{j}^{( l )} \}}^{↑} ( ⌊ 0.025 L ⌋ ) & ( 5 ) \\ {\tilde{η}}_{+} = {min}_{η} ( Pr ( wn {Π}_{j} < η ) \geq 0.975 ) \approx n {\{ {w}^{( l )} {Π}_{j}^{( l )} \}}^{↑} ( ⌊ 0.975 L ⌋ ) & ( 6 )\end{matrix}$$

in which:
for any x, the notation {x}^{↑} represents the collection of the samples x sorted in ascending order;
for any x and for any j, the notation {x}^{↑}(j) represents the j^{th} sample of the collection x sorted in ascending order.
Thus, {w^{(l)}Πⱼ^{(l)}}^{↑} represents the collection of the samples generated w^{(l)}Πⱼ^{(l)} sorted in ascending order;
└•┘ indicates the integer portion;
n represents the total number of photons recorded;
η represents a variable characterizing the intensity of the spectrum of peaks for the energy channel considered.

Once the spectrum of peaks sampled in energy is determined, a Kolmogorov-Smirnov test 210 can be applied.

The objective of this test 210 is to determine whether, over each interval Bⱼ the distribution of the quantity Σⱼ corresponding to the probability of the channel Bⱼ in the normalized complete spectrum, and defined by the expression:

Σⱼ=wΠⱼ+(1−w)Φⱼ (7)

is significantly distinct from the distribution of Γⱼ, Γⱼ being a quantity corresponding to the background alone on the j^{th} channel and being defined by the expression:

Γⱼ=(1−w)Φⱼ (8)

To do this, it is possible, for example, to implement a test of non-parametric assumptions making it possible to determine whether the two samples Σⱼ and Γⱼ associated with the j^{th} accumulation channel follow the same law or not.

The Kolmogorov-Smirnov test with two samples can be used in the context of the invention. For this, the quantity D_{L}(Γⱼ,Σⱼ) is determined by using the following expression:

$${D}_{L} ( {Γ}_{j} , {Σ}_{j} ) = \sqrt{\frac{L}{2}} {sup}_{η} \vert {CDF}_{\{ {Γ}_{j}^{( l )} \}} ( η ) - {CDF}_{\{ {Σ}_{j}^{( l )} \}} ( η ) \vert \qquad ( 9 )$$

in which:
{Σⱼ^{(l)}} represents the collection of the samples generated Σⱼ^{(l)} for l≦L;
{Γⱼ^{(l)}} represents the collection of the samples generated Γⱼ^{(l)} for l≦L;
CDF_{{Σ}_{ⱼ}_{^{(l)}}_{}}(η) the empirical cumulative function of the distribution of Σⱼ such that

$${CDF}_{\{ {Σ}_{j}^{( l )} \}} ( η ) = \frac{1}{L} {\sum }_{l = 1}^{L} ( {Σ}_{j}^{( l )} < η ) ;$$

CDF_{{Γ}_{ⱼ}_{^{(l)}}_{}}(η) the empirical cumulative function of the distribution of Γⱼ such that

$${CDF}_{\{ {Γ}_{j}^{( l )} \}} ( η ) = \frac{1}{L} {\sum }_{l = 1}^{L} ( {Γ}_{j}^{( l )} < η ) .$$

The Glivenko-Cantelli theorem ensures that, if Σⱼ and Γⱼ have the same distribution, then the quantity D_{L}(Γⱼ,Σⱼ) tends toward 0 when L tends toward infinity, almost certainly.

Kolmogorov provides an additional result on the speed of convergence; in practice, if Σⱼ and Γⱼ have the same distribution, then:

$${D}_{L} ( {Γ}_{j} , {Σ}_{j} ) {\to }_{L \to ∞} {sup}_{η} \vert B ( {CDF}_{\{ {Γ}_{j} \}} ( η ) ) \vert \qquad ( 10 )$$

in which expression B(•) is a Brownian bridge, the distribution K=sup(B(x)) being defined by the expression:

$$Pr ( K \leq x ) = 1 - 2 {\sum }_{i = 1}^{∞} {( - 1 )}^{i - 1} {e}^{- 2 {i}^{2} {x}^{2}} \qquad ( 11 )$$

Consequently, the assumption that the two samples Σⱼ and Γⱼ have distinct distributions, that is to say that there is a significant peak element over the interval Bⱼ, is verified if:

D_{L}(Γⱼ,Σⱼ)>K_{α} (12)

in which expression:
Pr(K≦K_{α})=1−α;
α is the level of significance (or risk).
   The typical values for α are of the order of 0.05. The value of K_{α} corresponds to the (1−α)-quantile of the Kolmogorov distribution obtained by inverting the expression (11).

In the context of spectrometric applications, the samples of {Σⱼ^{(l)}} and {Γⱼ^{(l)}} are correlated by the presence of the background Φⱼ^{(l)} in the two samples. Since any Πⱼ^{(l)} is greater than or equal to zero, CDF_{{Γ}_{ⱼ}_{^{(l)}}_{}}(η)≦CDF_{{Σ}_{ⱼ}_{^{(l)}}_{}}(η). Consequently, the following equality makes it possible to determine D_{L}(Γⱼ,Σⱼ):

$${D}_{L} ( {Γ}_{j} , {Σ}_{j} ) = \sqrt{\frac{L}{2}} {sup}_{η} ( {CDF}_{\{ {Σ}_{j}^{( l )} \}} ( η ) - {CDF}_{\{ {Γ}_{j}^{( l )} \}} ( η ) ) \qquad ( 13 )$$

where η represents a variable characterizing the intensity of the complete spectrum for the energy channel considered.

After computation 203 of the quantity D_{L}(Γⱼ,Σⱼ), the test corresponding to the inequality (12) is, for example, applied 204.

A simplified algorithm can be used to implement the Kolmogorov-Smirnov test 210, like the one described later in the description with the help of FIG. 3.

The result of the Kolmogorov-Smirnov test determines the processing steps to then be applied. In practice:
if D_{L}(Γⱼ,Σⱼ)>K_{α}, it is considered that a significant peak has been detected over the interval Bⱼ, and in this case, processing operations 205 are executed in order to analyze said peak;
if, on the contrary, D_{L}(Γⱼ,Σⱼ)≦K_{α}, it is considered that the current interval Bⱼ does not contain any significant peak.

A check is then carried out to see whether or not there are still accumulation channels to be analyzed 207.

If the current interval Bⱼ does not correspond to the last accumulation channel to be processed, j is incremented 208 and a Kolmogorov-Smirnov test is applied to the new current interval.

If the current interval Bⱼ corresponds to the last accumulation channel, the processing process is ended.

FIG. 3 gives an example of implementation of the Kolmogorov-Smirnov test in the context of a semi-parametric Bayesian spectrometry application in a channel Bⱼ.

This example comprises three phases. The first phase is an initialization phase 301, the second 311 corresponds to a computation loop and the third 312 to a so-called finalization phase.

The aim of the initialization phase is to initialize intermediate variables used by the second 311 and third 312 phases. These variables are, notably, the variables l_{Γ}, l_{Σ} and dₘₐₓ, and are initialized 301 such that:

l_{Γ}=0

l_{Σ}=0

dₘₐₓ=0
l_{Γ} corresponds to the range index of the collection CDF_{{Γ}_{ⱼ}_{^{(l)}}_{}}(l_{Γ});
l_{Σ} corresponds to the range index of the collection CDF_{{Σ}_{ⱼ}_{^{(l)}}_{}}(l_{Σ});
dₘₐₓ=max(l_{Γ}−l_{Σ}) corresponds to the maximum offset between the two indices defined previously.

The second phase 311, that is to say the computation loop, is then executed.

Hereinafter in the description, for any interval Bⱼ, the collection {Σⱼ^{(l)}}^{↑} corresponds to the collection of samples {Σⱼ^{(l)}} obtained by Gibbs sampling and arranged in ascending order.

According to the same notation principle, for any interval Bⱼ, the collection {Γⱼ^{(l)}}^{↑} corresponds to the collection of samples {Γⱼ^{(l)}} obtained by Gibbs sampling and arranged in ascending order.

A first test 302 is then applied so as to check the following inequality:

{Γⱼ^{(l)}}^{↑}(l_{Γ})≦{Σⱼ^{(l)}}^{↑}(l_{Σ}) (14)
where {Γⱼ^{(l)}}^{↑}(l_{Γ}) corresponds to the l_{Γ}^{th} sample of the collection {Γⱼ^{(l)}} sorted in ascending order. By analogy, Σⱼ^{(l)}}^{↑}(l_{Σ}) is the l_{Σ}^{th} sample of the collection {Σⱼ^{(l)}} sorted in ascending order.

If the inequality (14) is verified, the variable l_{Γ} is incremented 303, that is to say l_{Γ}=l_{Γ}+1.

If the inequality (14) is not verified, the variable l_{Σ} is incremented 304, that is to say l_{Σ}=l_{Σ}+1.

A second test 305 is then applied so as to check the following inequality:

dₘₐₓ<l_{Γ}−l_{Σ} (15)

If the inequality (15) is verified, the variable dₘₐₓ is updated 306 such that dₘₐₓ=l_{Γ}−l_{Σ}. Then a third test 307 is applied.

If the inequality (15) is not verified, the third test 307 is applied directly.

The aim of the third test 307 is to check whether the following inequality is verified:

l_{Γ}<L (16)

If the inequality (16) is verified, the second phase 311 is looped, that is to say that the processing operations described previously are executed again from the test 302 checking the inequality (14).

If the inequality (16) is not verified, the finalization phase 312 is executed.

The finalization phase 312 comprises a test 308, the aim of which is to check the following inequality:

$$\frac{1}{\sqrt{2 L}} {d}_{max} > {K}_{α} \qquad ( 17 )$$

A Boolean output variable vⱼ is defined so that it takes the value “1” if the presence of a significant peak element has been detected over the interval Bⱼ and the value “0” otherwise.

The value of vⱼ is determined according to the result of the test 308 checking the inequality (17).

If the inequality (17) is verified 310, vⱼ=1 and the presence of a peak is detected over the interval Bⱼ. If the inequality (17) is not verified 309, vⱼ=0.

FIG. 4 gives an example of the sequential construction processing of the regions of significant peaks.

A region of significant peaks corresponds to a region including at least one significant peak, said region being determined by determination of the contiguous accumulation channels Bⱼ for which vⱼ=1. This operation corresponds to a segmentation of the energy channels.

The objective of this processing operation is to provide a list of M regions R(m) (mε[1, . . . , M]), defined by their minimum jₘ⁻ and maximum jₘ⁺ indices, said indices corresponding to accumulation channel indices. The regions R(m) can be determined by using the following expression:

$$R ( m ) = {{⋃}_{j = {j}_{m}^{-}}}^{{j}_{m}^{+}} {B}_{j}$$

The minimum jₘ⁻ and maximum jₘ⁺ indices as well as the number of regions identified M are determined by executing the processing operations described below.

The aim of a first step 400 is to initialize intermediate variables. These variables are notably the variables j corresponding to the accumulation channel indices, m and δ which respectively represent the index of the current significant region and the size in number of channels of said region.

These three variables are set to zero.

A first test 401 is then applied so as to check whether vⱼ=1. In other words, it is verified that the current accumulation channel includes a significant peak or a significant peak portion.

If vⱼ=1, the variable δ is incremented 402, that is to say δ=δ+1.

Otherwise a second test 403 is applied, the objective of said test being to check whether vⱼ₋₁=1, that is to say to check whether the accumulation channel preceding the current channel contains a peak or a significant peak portion.

If vⱼ₋₁=1, the variables jₘ⁻, jₘ⁺, δ and m are updated 405 as follows:

jₘ⁺=j−1

jₘ⁻=j−δ

δ=0

m=m+1

A third test 406 is then applied, said test checking the following inequality:

j<J
where J is the number of energy channels.

If the inequality j<J is verified, the variable j is incremented 404, that is to say j=j+1, and the processing operations described previously are reexecuted from the first test 401.

If the inequality j<J is not verified, the variable M is updated so that M=m 407.

FIG. 5 illustrates the analyses that can be conducted after the application of the Kolmogorov-Smirnov test in order to analyze the peaks detected.

The collection of significant regions {Rₘ} makes it possible to estimate statistically by the MCMC procedure the characteristics of each region of peaks in terms of intensity and of location in energy, notably the centroid and the spread of said peaks.

The proposed method advantageously exploits the uncertainty associated with these characteristics in a posteriori distribution form. In effect, in addition to the a posteriori averages on these quantities, credibility intervals can be evaluated, or any other statistic associated with the regions of peaks.

Thus, the intensity of the peaks can be estimated 500.

For any m<M, over each Rₘ and for each draw of the MCMC procedure, a quantity λₘ^{(l)} is determined by using, for example, the expression:

$${λ}_{m}^{( l )} = {nw}^{( l )} {\sum }_{k = 1}^{N} {p}_{k}^{( l )} 1 ( {Z}_{k}^{( l )} ∈ {R}_{m} ) \qquad ( 18 )$$

where the function 1(Cond)=1 if the condition Cond is true and 1(Cond)=0 otherwise.

The intensity estimator for the region m is then given by the a posteriori average:

$${\hat{λ}}_{m} = \frac{1}{L} {\sum }_{l = 1}^{L} {λ}_{m}^{( l )} \qquad ( 19 )$$

A 95% credibility interval for λₘ is given by the quantiles of the collection {λₘ^{(l)}} by using, for example, the following expression:

CI_{95%}(λₘ)=└{λₘ^{(l)}}^{↑}(└0.025L┘),{λₘ^{(l)}}^{↑}(└0.975L┘)┘ (20)

in which the collection {λₘ^{(l)}}^{↑} corresponds to the collection of samples {λₘ^{(l)}} arranged in ascending order.

The semi-parametric Bayesian technique makes it possible to directly compute any other moment or functional of the distribution of λₘ.

It is also possible to estimate 501 the energy location of the centroid of each region of significant peaks.

For this, an estimation \tilde{p}ₖ^{(l)} of the average of the energy distribution restricted to Pₘ is determined. For any m<M, for each draw of the MCMC procedure and for any k such that Zₖ^{(l)}εRₘ, \tilde{p}ₖ^{(l)} can be determined by using the following expression:

$${\tilde{p}}_{k}^{( l )} = \frac{{p}_{k}^{( l )}}{{\sum }_{k = 1}^{N} {p}_{k}^{( l )} 1 ( {Z}_{k}^{( l )} ∈ {R}_{m} )} \qquad ( 21 )$$

For each iteration l, the number of components of the Dirichlet process for which the location Zₖ^{(l)}εRₘ is denoted Nₘ^{(l)} and is determined by using, for example, the following expression:

$${N}_{m}^{( l )} = {\sum }_{k = 1}^{N} 1 ( {Z}_{k}^{( l )} ∈ {R}_{m} ) \qquad ( 22 )$$

For any m<M, a quantity μₘ^{(l)} is then estimated over each significant region Rₘ and for each draw of the MCMC procedure by using, for example, the following expression:

$${μ}_{m}^{( l )} = {\sum }_{k = 1}^{N} {\tilde{p}}_{k}^{( l )} {Z}_{k}^{( l )} 1 ( {Z}_{k}^{( l )} ∈ {R}_{m} ) \qquad ( 23 )$$

The estimator of the centroid \hat{μ}ₘ for the region m is then given by the a posteriori average determined from the quantities (22) and (23) by using, for example, the expression:

$${\hat{μ}}_{m} = \frac{{\sum }_{l = 1}^{L} {μ}_{m}^{( l )}}{{\sum }_{l = 1}^{L} 1 ( {N}_{m}^{( l )} > 0 )} \qquad ( 24 )$$

The denominator of the expression (24) corresponds to the number of MCMC draws for which there is at least one component belonging to the region Rₘ, the other draws not being able to be taken into account in the Monte Carlo estimation.

The 95% credibility interval for μₘ is given by the quantiles of the collection {μₘ^{(l)}} and can be determined, for example, by using the following expression:

CI_{95%}(μₘ)=└{μₘ^{(l)}}^{↑}(└0.025L┘),{μₘ^{(l)}}^{↑}(└0.975L┘)┘ (25)

in which the collection {μₘ^{(l)}}^{↑} corresponds to the collection of samples {μₘ^{(l)}} arranged in ascending order.

The semi-parametric Bayesian technique makes it possible to directly compute any other moment or functional of the distribution of μₘ.

The regions of peaks can also be analyzed by estimating the extent of each region of significant peaks 502.

A number of quantities can be provided in order to appreciate this quantity. For example, an estimation of the standard deviation σₘ of the energy distribution restricted to the region Rₘ can be used.

For any m<M, over each Rₘ and for each draw of the MCMC procedure, the quantity σₘ^{(l)} is estimated by using, for example, the expression:

$${σ}_{m}^{( l )} = \sqrt[ ]{( {\sum }_{k = 1}^{N} {{\tilde{p}}_{k}^{( l )} ( {Z}_{k}^{( l )} )}^{2} 1 ( {Z}_{k}^{( l )} ∈ {R}_{m} ) ) - {( {\sum }_{k = 1}^{N} {\tilde{p}}_{k}^{( l )} {Z}_{k}^{( l )} 1 ( {Z}_{k}^{( l )} ∈ {R}_{m} ) )}^{2}} \qquad ( 26 )$$

The estimator \hat{σ}ₘ of the standard deviation of the energy distribution restricted to Rₘ is then estimated by the a posteriori average of σₘ^{(l)} by using, for example, the following expression:

$${\hat{σ}}_{m} = \frac{{\sum }_{l = 1}^{L} {σ}_{m}^{( l )}}{{\sum }_{l = 1}^{L} 1 ( {N}_{m}^{( l )} > 0 )} \qquad ( 27 )$$

The 95% credibility interval for σₘ is given by the quantiles of the collection σₘ^{(l)}

CI_{95%}(σₘ)=└{σₘ^{(l)}}^{↑}(└0.025L┘),{σₘ^{(l)}}^{↑}(└0.975L┘)┘ (28)

in which the collection {σₘ^{(l)}}^{↑} corresponds to the collection of samples {σₘ^{(l)}} arranged in ascending order.

The semi-parametric Bayesian technique makes it possible to directly compute any other moment or functional of the distribution of σₘ.

The standard deviation σₘ, in the case of a Gaussian law over Rₘ, can be an indicator of the extent of Rₘ denoted \hat{Δ}_{R}_{ₘ} which can be determined by using, for example, the following expression:

\hat{Δ}_{R}_{ₘ}≈5\hat{σ}ₘ (29)

Given that the restriction of the energy distribution to any Rₘ may be significantly different from a Gaussian law, the estimator \hat{σ}ₘ may not be relevant for estimating the extent of the region. An estimation of the 99% stronger probability interval of the restriction to Rₘ of the energy density, denoted Δ_{m,99%}, can be estimated.

Δ_{m,99%} corresponds to the width of the region of peaks taken at its base. For this quantity, an estimator based on its conditional average and a 95% credibility interval are proposed.

For any m<M, over each Rₘ and for each draw of the MCMC procedure, the cumulative function of the distribution of the energy CDF_{R}_{ₘ}^{(l)}(ξ) restricted to Rₘ is estimated by using, for example, the expression:

$${CDF}_{{R}_{m}}^{( l )} ( ξ ) = {\sum }_{k = 1}^{N} {\tilde{p}}_{i}^{( l )} 1 ( {Z}_{k}^{( l )} < ξ ) 1 ( {Z}_{k}^{( l )} ∈ {R}_{m} ) \qquad ( 30 )$$

where ξ is a variable representing the energy.
Δ_{m,99%} can then be deduced from the following expression:

Δ_{m,99%}^{(l)}=[Q_{R}_{ₘ}^{(l)}(0.005),Q_{R}_{ₘ}^{(l)}(0.995)] (31)

in which:
Q_{R}_{ₘ}^{(l)}(•) is the quantiles function (inverse of CDF_{R}_{ₘ}^{(l)}(ξ)) such that, for any αε[0.1], Q_{R}_{ₘ}^{(l)}(α)=ξ_{α} [symbol] CDF_{R}_{ₘ}^{(l)}(ξ_{α})=α.

The estimator Δ_{m,99%} of Δ_{m,99%}, equivalent to the 99% greater probability interval of the energy distribution restricted to Rₘ, is then given by the a posteriori average of Δ_{m,99%}^{(l)}, that is to say by the expression:

$${\hat{Δ}}_{m , 99 \%} = \frac{{\sum }_{l = 1}^{L} {Δ}_{m , 99 \%}^{( l )}}{{\sum }_{l = 1}^{L} 1 ( {N}_{m}^{( l )} > 0 )} \qquad ( 32 )$$

The 95% credibility interval for Δ_{m,99%} is given by the quantiles of the collection {Δ_{m,99%}^{(l)}}, that is to say by the expression:

CI_{95%}(Δ_{m,99%})=[{Δ_{m,99%}^{(l)}}^{↑}(└0.025L┘),{Δ_{m,99%}^{(l)}}^{↑}(└0.975L┘)] (33)

in which the collection {Δ_{m,99%}^{(l)}}^{↑} corresponds to the collection of samples {Δ_{m,99%}^{(l)}} arranged in ascending order.

The semi-parametric Bayesian technique advantageously makes it possible to directly compute any other moment or functional of the distribution of Δ_{m,99%}.

1. A method for analyzing spectrometric measurements, said measurements C={c₁, . . . , cᵣ} being organized in a histogram, said histogram being made up of accumulation channels, a channel j corresponding to an energy interval Bⱼ, said method comprising at least three processing steps:
a first step determining, for each accumulation channel j, distributions p representative of the amplitude and Z representative of the position of the Dirac pulses that make up the normalized spectrum of peaks as well as distributions q representative of the Pólya tree characterizing the normalized background spectrum, said elements being obtained by Gibbs sampling;
a second step of detecting the significant channels, said detection being performed by the application of a Kolmogorov-Smirnov test for each accumulation channel of the histogram on the basis of the results of the first step;
a third step of identifying significant regions of the spectrum by grouping together the intervals Bⱼ of the significant channels identified during the second step, said regions including at least one significant peak.

2. The method as claimed in claim 1, wherein the spectrum of peaks is determined for any accumulation channel of index j, by using Monte-Carlo estimators defined by an expression such as:
$$E ( wn {Π}_{j} \vert C ) = \frac{n}{L} {\sum }_{l = 1}^{L} {w}^{( l )} {Π}_{j}^{( l )}$$
in which:
Πⱼ^{(l)} corresponds to the probability mass of the channel Bⱼ for the l^{th} draw of the MCMC process;
L corresponds to the number of Monte Carlo draws of the Gibbs sampler;
wε[0.1] is the probability of the spectrum of peaks in the complete spectrum defined as being the weighted sum of the normalized spectrum of peaks and of the normalized background spectrum;
w^{(l)} represents the weight of the spectrum of peaks for the l^{th} draw of the MCMC process;
n is the number of photons recorded.

3. The method as claimed in claim 1, wherein the background spectrum is determined for any accumulation channel of index j, by using the following expression:
$$E ( ( 1 - w ) n {Φ}_{j} \vert C ) = \frac{n}{L} {\sum }_{l = 1}^{L} ( 1 - {w}^{( l )} ) {Φ}_{j}^{( l )}$$
in which:
Φⱼ^{(l)} represents the generated values of the random variable Φⱼ on the iteration l of the sampler, Φⱼ representing the probability mass of the channel Bⱼ of the normalized background spectrum for each j.

4. The method as claimed in claim 1, wherein the uncertainty associated with each energy channel is estimated by defining a 95% credibility interval [\tilde{η}₋,\tilde{η}₊] determined by using the following expressions:
$${\tilde{η}}_{-} = min ( Pr ( wn {Π}_{j} < η ) \geq 0.025 ) \approx n \{ {w}^{( l )} {Π}_{j}^{( l )} \} ↑ ( ⌊ 0.025 L ⌋ ) {\tilde{η}}_{+} - {min}_{η} ( Pr ( wn {Π}_{j} < η ) \geq 0.975 ) \approx n \{ {w}^{( l )} {Π}_{j}^{( l )} \} ↑ ( ⌊ 0.975 L ⌋ )$$
in which:
for any x, the notation {x}^{↑} represents the collection of the samples x sorted in ascending order;
for any x and for any j, the notation {x}^{↑}(j) represents the j^{th} sample of the collection x sorted in ascending order;
thus, {w^{(l)}Πⱼ^{(j)}}^{↑} represents the collection of the samples generated w^{(l)}Πⱼ^{(l)} sorted in ascending order;
└•┘ indicates the integer portion;
n represents the total number of photons recorded;
η represents a variable characterizing the intensity of the spectrum of peaks for the energy channel considered.

5. The method as claimed in claim 1, wherein a quantity D_{L}(Γⱼ,Σⱼ) is determined for application of the Kolmogorov-Smirnov test (210) by using the expression:
$${D}_{L} ( {Γ}_{j} , {Σ}_{j} ) = \sqrt{\frac{L}{2}} {sup}_{η} \vert {CDF}_{\{ {Γ}_{j}^{( l )} \}} ( η ) - {CDF}_{\{ {Σ}_{j}^{( l )} \}} ( η ) \vert$$
in which:
Σⱼ corresponds to the probability of the channel Bⱼ in the complete normalized spectrum;
Γⱼ is a quantity corresponding to the background alone;
{Σⱼ^{(l)}} represents the collection of the samples generated Σⱼ^{(l)} for l≦L;
{Γⱼ^{(l)}} represents the collection of the samples generated Γⱼ^{(l)} for l≦L;
CDF_{{Σ}_{ⱼ}_{^{(l)}}_{}}(η) the empirical cumulative function of the distribution of Σⱼ such that
$${CDF}_{\{ {Σ}_{j}^{( l )} \}} ( η ) = \frac{1}{L} {\sum }_{l = 1}^{L} ( {Σ}_{j}^{( l )} < η ) ;$$
CDF_{{Γ}_{ⱼ}_{^{(l)}}_{}}(η) the empirical cumulative function of the distribution of Γⱼ such that
$${CDF}_{\{ {Σ}_{j}^{( l )} \}} ( η ) = \frac{1}{L} {\sum }_{l = 1}^{L} ( {Γ}_{j}^{( l )} < η ) ;$$
η represents a variable characterizing the intensity of the complete spectrum for the energy channel considered.

6. The method as claimed in claim 5, wherein the presence of a significant peak element over an interval Bⱼ is detected if D_{L}(Γⱼ,Σⱼ)>K_{α}, K_{α} being defined such that Pr(K≦K_{α})=1−α, α corresponding to a chosen level of significance.

7. The method as claimed in claim 1, further comprising a step of estimating the intensity of the peaks over a significant region Rₘ, said intensity being determined by using the expressions:
$${\hat{λ}}_{m} = \frac{1}{L} {\sum }_{l = 1}^{L} {λ}_{m}^{( l )} with {λ}_{m}^{( l )} = {nw}^{( l )} {\sum }_{k = 1}^{N} {p}_{k}^{( l )} 1 ( {Z}_{k}^{( l )} ∈ {R}_{m} )$$
in which:
the function 1(Cond)=1 if the condition Cond is true and 1(Cond)=0 otherwise;
{Rₘ} the collection of significant regions of the spectrum;
Zₖ is the position of the component k of the Dirichlet process produced by the MCMC procedure.

8. The method as claimed in claim 7, further comprising a step of computing a 95% credibility interval for λₘ by using the expression:
CI_{95%}(λₘ)=└{λₘ^{(l)}}^{↑}(└0.025L┘),{λₘ^{(l)}}^{↑}(└0.975L┘)┘
in which the collection {λₘ^{(l)}}^{↑} corresponds to the collection of samples {λₘ^{(l)}} arranged in ascending order.

9. The method as claimed in claim 1, further comprising a step of estimating the centroid \hat{λ}ₘ of each region of significant peaks by using the following expression:
$${\hat{μ}}_{m} = \frac{{\sum }_{l = 1}^{L} {μ}_{m}^{( l )}}{{\sum }_{l = 1}^{L} 1 ( {N}_{m}^{( l )} > 0 )}$$
in which:
μₘ^{(l)} is a quantity estimated over each significant region Rₘ and for each draw of the MCMC procedure by using the expression:
$${μ}_{m}^{( l )} - {\sum }_{k = 1}^{N} {\tilde{p}}_{k}^{( l )} {Z}_{k}^{( l )} 1 ( {Z}_{k}^{( l )} ∈ {R}_{m} ) ;$$
the denominator corresponds to the number of MCMC draws for which there is at least one component belonging to the region Rₘ, the other draws not being able to be taken into account in the Monte Carlo estimation.

10. The method as claimed in claim 9, further comprising a step of computing a 95% credibility interval for μₘ by using the expression:
CI_{95%}(μₘ)=└{μₘ^{(l)}}^{↑}(└0.025L┘),{μₘ^{(l)}}^{↑}(└0.975L┘)┘
in which the collection {μₘ^{(l)}}^{↑} corresponds to the collection of samples {μₘ^{(l)}} arranged in ascending order.

11. The method as claimed in claim 1, further comprising a step of estimating \hat{σ}ₘ the standard deviation σₘ of the energy distribution restricted to the region Rₘ by using the expression:
$${\hat{σ}}_{m} = \frac{{\sum }_{l = 1}^{L} {σ}_{m}^{( l )}}{{\sum }_{l = 1}^{L} 1 ( {N}_{m}^{( l )} > 0 )}$$
in which:
$${σ}_{m}^{( l )} = \sqrt{( {\sum }_{k = 1}^{N} {{\tilde{p}}_{k}^{( l )} ( {Z}_{k}^{( l )} )}^{2} 1 ( {Z}_{k}^{( l )} ∈ {R}_{m} ) ) - {( {\sum }_{k = 1}^{N} {\tilde{p}}_{k}^{( l )} {Z}_{k}^{( l )} 1 ( {Z}_{k}^{( l )} ∈ {R}_{m} ) )}^{2}}$$

12. The method as claimed in claim 11, further comprising a step of computing a 95% credibility interval for σₘ by using the expression:
CI_{95%}(σₘ)=└{σₘ^{(l)}}^{↑}(└0.025L┘),{σₘ^{(l)}}^{↑}(└0.975L┘)┘
in which the collection {σₘ^{(l)}}^{↑} corresponds to the collection of samples {σₘ^{(l)}} arranged in ascending order.

13. The method as claimed in claim 1, further comprising a step of estimating the width of the deconvoluted region at its base, defined as the interval of 99% higher probability of the restriction to Rₘ of the energy density (denoted Δ_{m,99%}), by using the expression
$${\hat{Δ}}_{m , 99 \%} = \frac{{\sum }_{l = 1}^{L} {Δ}_{m , 99 \%}^{( l )}}{{\sum }_{l = 1}^{L} 1 ( {N}_{m}^{( l )} > 0 )}$$
in which:
Δ_{m,99%}^{(l)}=[Q_{R}_{ₘ}^{(l)}(0.005),Q_{R}_{ₘ}^{(l)}(0.995)] where
$${Q}_{{R}_{m}}^{( l )} ( α ) = {ξ}_{α} ⇐ {CDF}_{{R}_{m}}^{( l )} ( {ξ}_{α} ) = α and {CDF}_{{R}_{m}}^{( l )} ( ξ ) = {\sum }_{k = 1}^{N} {\tilde{p}}_{l}^{( l )} 1 ( {Z}_{k}^{( l )} < ξ ) 1 ( {Z}_{k}^{( l )} ∈ {R}_{m} ) .$$

14. The method as claimed in claim 13, further comprising a step of computing a 95% credibility interval for Δ_{m,99%} by using the expression:
CI_{95%}(Δ_{m,99%})=└{Δ_{m,99%}^{(l)}}^{↑}(└0.025L┘),{Δ_{m,99%}^{(l)}}^{↑}(└0.975L┘)┘
in which the collection {Δ_{m,99%}^{(l)}}^{↑} corresponds to the collection of samples {Δ_{m,99%}^{(l)}} arranged in ascending order.

15. A device for analyzing spectrometric measurements, said measurements C={c₁, . . . , cᵣ} being organized in a histogram, said histogram being made up of accumulation channels, a channel j corresponding to an energy interval Bⱼ, said device comprising means for implementing the method as claimed in claim 1.
